(19) United States
(12) Patent Application Publication
(10) Pub. No.: US 2006/0092994 A1
(43) Pub. Date: May 4, 2006

(54) High-power amplified spectrally combined mode-locked laser

(75) Inventors: Robert D. Frankel, Rochester, NY (US); John Hoose, Fairport, NY (US)

Correspondence Address: FISH & NEAVE IP GROUP;ROPES & GRAY LLP, ONE INTERNATIONAL PLACE, BOSTON, MA, 02110-2624, US

(73) Assignee: Chromaplex, Inc., West Henrietta, NY (US)

(21) Appl. No.: 10/997,224

(22) Filed: Nov. 23, 2004

Related U.S. Application Data
(63) Continuation-in-part of application No. 10/978,808, filed on Nov. 1, 2004.

(51) Int. Cl. H01S 3/098

(52) U.S. Cl. 372/18

(57) ABSTRACT

An amplified commonly mode-locked and/or Q-switched external cavity laser device with a plurality of gain elements and a plurality of amplifying elements is described. The device produces amplified optical pulses of picosecond to nanoseconds duration. The amplified pulses can be used in applications requiring large optical pulse energy and also high average optical power, such as material processing, nonlinear optics, extreme UV spectroscopy, and generation of x-rays.

### CROSS-REFERENCE TO OTHER PATENT APPLICATIONS

This application is a continuation-in-part of U.S. patent application Ser. No. 10/978,808, filed Nov. 1, 2004, the content of which is incorporated herein by reference in its entirety.

### BACKGROUND OF THE INVENTION

The invention relates to an external cavity laser device with a plurality of commonly mode-locked and/or Q-switched gain elements, and more particularly to a laser device with a multi-element fiber amplifier producing a combined output beam of picosecond or nanosecond pulses with high peak energy and high average power.

Many applications require high-power lasers with a suitable pulse width and capable of a high repetition rate. In particular, there is an increasing need for high peak power and high average power nanosecond lasers for many applications. These lasers are often used to take advantage of the non-linear interaction of high intensity optical pulses with matter. Non-linear interactions can occur when the focused optical field is raised to 10⁸-10¹⁶ W/cm² or more. In addition, with pulse durations in the nanosecond range, a plasma may be formed at the focal spot of a laser that emits x-ray and/or extreme ultraviolet (EUV) radiation. The pulse energy for achieving x-ray generation should be greater than 0.5 J with a pulse width of less than 20 nsec and the beam should be focused to a less than 200 μm focal spot. Applications for focused plasma x-ray generation include x-ray microscopy, and EUV microlithography. In particular, EUV lithography requires that the laser delivers up to 2 joules/pulse, with a pulse width of less than 16 and a repetition rate of 17 kHz, producing a 34 kW average power laser system. Other applications of these lasers include surface cleaning, and materials processing.

Waveguide lasers, such as fiber lasers and semiconductor lasers, are known to be efficient and capable of generating a high output power. However, the output power and energy is limited by thermal considerations and induced facet damage at high output power density. Adding individual fibers in a single lens is not effective due to the limited numerical aperture of each collimated fiber. To overcome this obstacle, a plurality of fiber optic gain elements, a lens, a wavelength dispersive element, and a partially reflecting element can be arranged in an external cavity to generate a high-power overlapping or coaxial beam in the same aperture.

Short laser pulses with high peak power can be produced, for example, by Q-switching or by mode-locking. A particularly useful modulator of laser cavity transmission that may be used as a mode locker and/or Q-switcher is an intra-cavity semiconductor saturable absorber mirror (SESAM). SESAMs have been successfully used for mode-locking individual semiconductor diode lasers, and for Q-switching microchip lasers. However, this approach has a limited optical peak power, because care has to be taken that the pulse energy does not cause catastrophic facet damage. The design of saturable absorbers can be optimized for either Q-switching or mode-locking; for example, by tailoring the recovery time to the cavity design and having pulse energy that is 3-5 times the saturation fluence. The incident pulse energy on the saturable absorber can be adjusted by the incident mode area, i.e. how strongly the cavity mode is focused on the saturable absorber.

It would therefore be desirable to overcome the peak power limitations caused by facet-loading in mode-locked and Q-switched fiber and diode lasers and to provide a fiber or semiconductor lasing device that can generate short optical pulses with a high pulse energy while simultaneously operating at high average power in a common aperture to achieve a small focus spot.

### SUMMARY OF THE INVENTION

The described device and method are directed, inter alia, to an external cavity fiber or semiconductor laser source that can generate short (picosecond to nanosecond) pulses with high peak power and high average power, and more particularly to an amplified laser system with a plurality of gain elements and amplifying elements, wherein each amplifying element receives an input beam from a gain element, and the gain elements are commonly mode-locked and/or Q-switched.

According to one aspect of the invention, a laser device includes a plurality of optical gain elements emitting corresponding laser beams, a first beam combiner that combines the laser beams to form an overlapping beam, and a mode-locking device that intercepts the overlapping beam and commonly mode-locks the laser beams. The laser device further includes a plurality of optical amplifying elements, whereby each amplifying element receives an output beam from a corresponding optical gain element and produces an amplified beam, and a second beam combiner that combines the amplified beams to produce an overlapping amplified output beam.

According to another aspect of the invention, a laser device includes a plurality of optical gain elements emitting corresponding laser beams, a first beam combiner that combines the laser beams to form an overlapping beam, and a Q-switch that intercepts the overlapping beam and commonly Q-switches the laser beams. The laser device further includes a plurality of optical amplifying elements, whereby each amplifying element receives an output beam from a corresponding optical gain element and produces an amplified beam, and a second beam combiner that combines the amplified beams to produce an overlapping amplified output beam.

In one advantageous embodiment, the laser device may include a phase-measuring device intercepting a portion of the overlapping beam and determining a phase characteristic of the overlapping beam, and a phase adjuster configured to separately adjust an optical path length, such as a geometric path and/or a refractive index of an optical element disposed in the optical path of the laser elements, in response to the determined phase characteristic. For example, the refractive index can be adjusted by injecting carriers into at least a region of the laser elements, whereas geometrical path can be adjusted with, for example, an intra-cavity prism, a liquid crystal and a chirped dielectric mirror disposed in the optical path. The phase-measuring device can be, for example, a Frequency-Resolved Optical Gating (FROG) device, and can simultaneously determine the phase relationship between the gain elements based on the phase characteristic of the overlapping pulsed output beam.

Other advantageous embodiments may include one or more of the following features. The gain elements can include optical waveguides, such as semiconductor waveguides and/or optical fibers, which can be doped with Ytterbium and/or Erbium, as well as microlasers and rare earth doped waveguides. The mode locking device may be a semiconductor saturable absorber mirror (SESAM) or an active mode locking device that can optionally be configured to retro-reflect the overlapping beam to the first beam combiner.

The first and second beam combiners can be diffractive elements, such as a grating.

Advantageously, the laser device can be an external cavity laser device and can further include an intra-cavity etalon that narrows a spectral width of the laser beams emitted by the optical gain elements.

According to another advantageous feature of the invention, the amplifying elements can be optically pumped fibers, for example polarization-maintaining fibers, that can operate either in single-mode or in multi-mode, in which case the fibers can be bent so as to operate substantially in single mode. The amplifying elements can also be implemented as electrically pumped semiconductor waveguides.

The laser device can advantageously also include an optical coupling unit that couples the output beam from an optical gain element to a respective one of the optical amplifying elements. The optical coupling unit can include an optical switch, for example a Pockels cell, that selects specific pulses from the output beams of the gain elements for transmission to the corresponding amplifying element, preferably according to a timing signal that is synchronized with the commonly mode-locked laser beams.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1. shows schematically a commonly mode-locked laser system with a connected optical amplifier section;

FIG. 2 shows schematically the commonly mode-locked external cavity laser gain section with mode-locker and phase controller;

FIG. 3 shows schematically a beam coupler for coupling the laser gain section to the optical amplifier section; and

FIG. 4 shows schematically the optical amplifier section producing an overlapping mode-locked output beam.

### DETAILED DESCRIPTION OF CERTAIN ILLUSTRATED EMBODIMENTS

The system described herein is directed to a laser system with a plurality of gain elements, such as optical fibers, laser crystals, e.g. microlasers, and semiconductor lasers that are mode-locked in common in an external cavity. The system is also directed to an amplified laser system wherein the output of each gain element is directed to a separate fiber amplifier section, with the output beams from the amplifier section spectrally combined into a common amplified overlapping output beam.

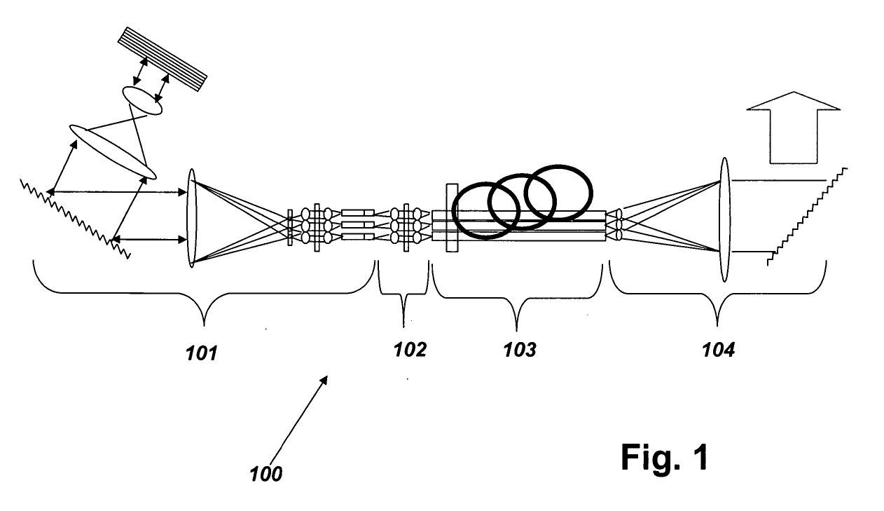

FIG. 1 shows schematically an amplified laser system 100 with an oscillator section 101 with a plurality of separate gain elements that generate commonly mode-locked and/or Q-switched laser beams, and an amplifier section 103 with a plurality of amplifying fibers that receive the laser beams from the oscillator section 101 and produce amplified laser beams, which are then collimated and combined by beam combiner section 104 into a common overlapping amplified output beam. The oscillator section 101 and the amplifier section 103 are coupled by a coupling section 102 that may include additional beam shaping optics, as described below.

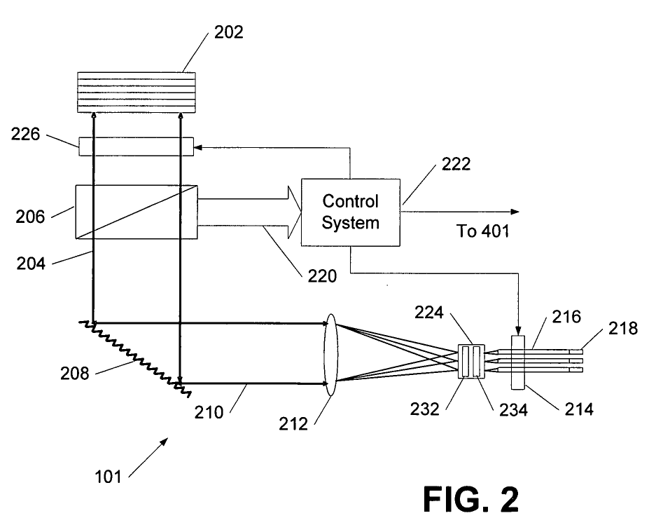

FIG. 2 shows schematically an exemplary mode-locked external cavity laser system 101 with an array of gain elements 216. In the depicted embodiment, the external cavity is formed by, for example, semitransparent end mirrors 218 and a common Q-switching device or mode-locker 202, such as a semiconductor saturable absorber mirror (SESAM). Hereinafter the term SESAM will be used as an exemplary mode-locker and is meant to also include other Q-switching devices and mode-lockers, such as for example electro-optic Pockels cells and acousto-optic modulator devices. Disposed inside the cavity is also a diffractive element (grating) 208 that diffracts the lasers beams 210 emitted by gain elements 216 after collimation by a lens 212. Although the collimated laser beams 210 are shown in FIG. 2 as a single beam, the different collimated beams emitted by the different gain elements 216 will actually be at a slight angle with respect to one another. The diffracted beam 204 is preferably a collinear overlapping beam 210 formed from and having the spectral contents of all the individual laser beams 210. The overlapping beam 204 is reflected by SESAM 202 and diffracted on its return path by the grating 208, with the separated spectral contents of beam 210 completing its round trip to the gain elements 216.

A portion of the overlapping beam 204 can be extracted by a beam splitter or partially reflective mirror 206 to form an overlapping output beam 220. Output beam 220 is received by a control system 222 that measures, inter alia, the time of arrival and the relative phases of the spectral lines associated with the various gain elements 216. The control system 222 can also be used to control additional beam shaping elements, as will be described below. Since the gain elements 216 tend to operate independently, they are typically not spatially or temporally phase-coherent. A multi-gain element pulsed system can be considered as being phase-coherent if the peak central amplitude of the electric field of the locked envelope of modes that make up the mode-locked pulse from each element are traveling together, completely overlapped, or with a constant offset, both in space and in time during a round trip through the cavity. Adjusting the phase, i.e. round trip travel time, of the light emerging from each laser is critical for continuous mode-locking of all gain elements.

The relative phase of each laser element 216 can be adjusted by inserting in the corresponding optical path an externally adjustable phase-shifter 214. Phase shifters operate, for example, by changing the optical length n· [symbol] in an optical path, wherein n is the refractive index of the material forming the optical path and [symbol] is the length of the optical path. The optical length can be changed by adjusting either n or [symbol] , or both. This may be achieved by passive or active means. For example, if the optical path [symbol] is represented by a semiconductor waveguide, then a suitable adjustment of the optical path length may be made by individual waveguide sections by injecting carriers in the individual semiconductor waveguides which alter the refractive indices of each section. The optical path length for fiber gain media may be adjusted by heating or stretching individual fibers. Alternatively or in addition, deterministic phase differences between gain element due to wavelength dispersion or other wavelength-dependent diffractive path length differences may be compensated by adjusting the length of gain elements, or by using intra-cavity prism pairs, or other means of intra-cavity round trip compensation sections, such as liquid crystal arrays, which may also be dynamically adjusted, or chirped dielectric mirrors. Phase adjustments can therefore be easily performed.

An exemplary phase measurement system known in the art that can be used for measuring spectrograms (frequency-time domain plots) is referred to as FROG (Frequency-Resolved Optical Gate). FROG is an autocorrelation-type measurement in which the autocorrelator signal beam is spectrally resolved. Instead of measuring the autocorrelator signal energy vs. delay directly, which yields an autocorrelation, FROG involves measuring the signal spectrum vs. delay. Other phase-measurement systems known in the art can be used instead of FROG. The phase of each laser can hereby be monitored and feedback can be provided to the system to adjust the phase of the light from each laser. Such correction is possible in real time.

Continuously operating mode locked lasers emit less energy per pulse than Q-switched lasers or a mode-locked/Q-switched laser at the peak of the pulse envelope. The energy of the optical output pulses from the gain elements 216 can be increased by using an additional active Q-switch 226, which produces a train of actively switched mode locked pulses, or by having the Q-switch also perform the mode-locking function. Q-switching in conjunction with mode-locking may be required for fiber gain elements 216 because traditional Q-switched pulses can be quite long, for example in excess of 40-1000 ns, due to the relatively long cavity round trip times. In many applications, a pulse width of less than approximately 15 ns is desirable.

If the mode-locker 202 operates in a Q-switched-mode locked regime, or if there is an additional Q-switch, whereby the laser does not operate in a continuous mode-locked regime, but rather with a short train of mode-locked pulses, then the accumulated round trip de-phasing may be greatly reduced for non-perfectly matched fibers. This is the case because the first opening of the Q-switched/mode locker 202 will start the round trips for each gain element together, therefore resetting the start time for each fibers round trip. Since only 5-20 round trips are used to extract energy in a Q-switched-mode locked train, the amount of de-phasing will likely be minimal for 1-10 nanosecond mode-locked pulses. Therefore, in certain applications, commonly Q-switched-mode locked operation can result in a simpler system, and minimize the need for exact phase matching between fiber gain element path lengths.

The spectral width of the individual laser beams 210 produced by gain elements 216 can be narrowed by inserting in the individual beam paths an etalon 234. Since the etalon 234 requires a collimated beam, a beam shaper 232, such as a pinhole array 232, and a collimating lens or lens array (not shown) for beam collimation are also inserted. The etalon can be composed of reflective glass plates with a Free Spectral Range (FSR) equal to or less than the frequency separation between individual gain elements 216. This is accomplished by controlling both the Free Spectral Range (FSR) and the finesse of the etalon. The finesse, or width of the spectral band pass, is controlled by the reflectivity of each glass plate of the etalon. The higher the reflectivity of the plates, the narrower the spectral pass band. The FSR, which defines spectral separation between pass bands, should be equal to or less than the frequency separation between individual gain elements 216 to provide the greatest freedom in choice of wavelength band and larger than the spectral acceptance of each fiber as it receives spectrally dispersed light from the grating. This will control the spectral bandwidth (frequency range) emitted from each gain element and thus the pulse width of each spectral beam. Bandwidths of 10 GHz to 100 MHz may be chosen to provide output pulse widths between 100 ps and 10 ns.

Alternatively, the etalon may also be placed in the overlapping beam 204, which advantageously eases the manufacturing tolerances of the etalon because the angle of incidence is the same for all wavelengths. The placement of the etalon in FIG. 2 may require an etalon with a small curvature or tilt to compensate for the different angle of incidence of each beam.

It should be noted that a transmission mode locker/or Q-switch device may also be inserted in the collimated beam instead of in the overlapped diffracted beam (not shown). The grating can then be operated in Littrow configuration.

Referring back to FIG. 1 and also to FIG. 2, of the laser beams from the individual gain elements 216 are emitted at corresponding output mirrors 218 of the gain elements 216. The cavity end mirrors 218, 202 provide nodes in the oscillating fields of each mode and therefore also provide spatial phase correlation. The simultaneous opening of all the cavities by the SESAM ensures temporal overlap of the lasing modes. However, the temporal overlap may deteriorate, e.g., if independent reentrant lengths change due to thermal fluctuations in the gain media. In this case, the pulse from a laser with a mistimed lasing path can arrive when the SESAM is closing, or has not yet opened, thus suppressing feedback for that laser. Since the gain in the media builds up exponentially, the energy output from the mistimed laser will be reduced significantly, and the mistimed laser can be identified, for example, from an intensity dip in the frequency band associated with that laser, rather than, as discussed above, from a phase mismatch, which is the traditional method of measuring a phase mismatch between independently operating lasers. Stable operation can be achieved by changing the cavity path lengths through active feedback, for example with the control system 222, as described above.

The energy achievable with the proposed system depends, inter alia, on the number of gain elements that can simultaneously operate. Since glass fiber gain media and semiconductor lasers have bandwidths of 50 nm or greater, a large number of gain elements, potentially more than one hundred, may be operated in parallel.

The SESAM 202 should preferably have a spectral reflectivity range that encompasses the overall wavelength range of the laser elements 216 to be included in the output beams at mirror elements 218. A tunability range of 50 nm has been reported for AlAs—AlGaAs multi quantum well (MQW) Bragg mirrors used with a diode-pumped Cr:LiSAF laser. A stop band (bandwidth) of greater than 100 nm has been reported for GaAs—AlGaAs distributed Bragg reflectors used with a Yb-doped fiber laser. A SESAM with a GaInNAs-based absorber has also been reported. SESAM's of this type would be suitable for the present application.

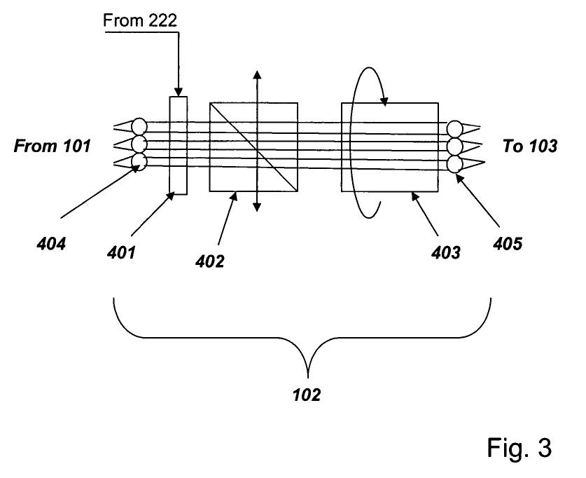

Referring now to FIGS. 3 and 1, the pulsed output beams emitted from output facets 218 of the individual gain elements 216 are transmitted to amplifier section 103 via beam coupler 102. A collimating lens array 404 separately collimates the individual beams, which then successively pass through an optical switch 401, e.g., a Pockels cell, a polarizer 402, and a Faraday rotator 403. Pockels cell 402 is an electrooptic device made of birefringent materials, such as KD*P, that have a high voltage-controllable electrooptic coefficient. A control voltage can be supplied, for example, by controller 222, as indicated in FIG. 3 by the arrow. A voltage applied to the Pockels cell alters the birefringence of the material, which changes the polarization of the exit beams from the Pockels, which then either pass through or are blocked by the polarizer 402. The exemplary Pockels cells can operate at switching frequencies up to 20-50 kHz. A continuously mode-locked laser typically operates at frequencies of 10-50 MHz, whereas a Q-switched laser may operate at 20-20 kHz. Q-switched pulse selection may therefore be required to match the speed of the Pockels cell to that of the mode-locked/Q-switched pulses. However, a Pockels cell switch may not be desirable or required for operation at higher repetition rates. The switched beams then pass through the Faraday rotator 403 which blocks light from being retro-reflected into the gain media.

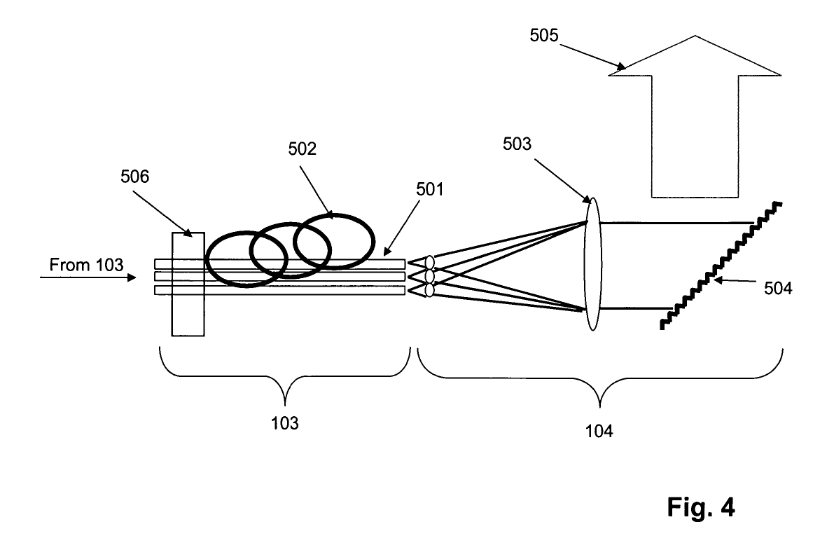

The output of the Pockels cell is focused by collimating lens array 405 on to the amplifier section 103, which is shown in detail in FIG. 4. Amplifier section 103 has a plurality of amplifier elements 501, preferably, but not necessarily, in one-to-one correspondence with gain elements 216. The amplifier elements 502 may be optically pumped, single mode, polarization preserving fibers doped with Erbium (Er) capable of amplifying input beams a band centered at 1.55 μm, or fibers doped with Ytterbium (Yb) capable of amplifying input beams a band centered at 1.08 μm. Advantageously, glass fibers Er- and Yb-doped glass fibers can have a gain bandwidth of 50 nm or more, so that a single material can be used over a wide combined emission range of the gain elements 216. For example, with a 25 GHz frequency spacing between the gain elements 216 in the oscillator section 101, in excess of 300 fibers may be arrayed in parallel. Alternatively or in addition, the amplifier elements 501 may be constructed entirely or in part from, for example, electrically pumped semiconductor waveguides.

It is desirable to operate the system with fibers having a relatively large core diameter as the energy out of each fiber tends to be limited by facet damage. Single mode fibers typically have core diameters of 8 μm or less. Recently 30 μm diameter core polarization-maintaining fibers have been reported, which when bent, as indicated schematically by the fiber loops 502 in FIG. 4, may operate close to single mode due to leakage of higher order modes. Large core fibers can produce amplified 50 ns pulses with a pulse energy of 4 mJ at high repetition rates.

The amplified laser beams exiting gain elements 501 are collimated by the lens 503 and impinge on a beam combining diffractive element (grating) 504 that produces an overlapping amplified high power pulsed output beam 505 having all the wavelengths of the individual MOPA gain elements 501. A phase-adjusting element 506 can optionally be provided to separately and actively adjust the output phase of each fiber, similar to the phase adjustment described above with reference to oscillator section 101.

Optionally, the output beam may be chirped so as to spread the arrival time at a target for pulses having different wavelengths over time. This may be arranged by changing the length of each fiber amplifier. An optical isolator, similar to the Faraday rotator/polarizer arrangement of FIG. 3, may be placed in the output beam to prevent back-reflection of light into the gain elements, which could result in unwanted lasing in the absence of the seed pulses.

The beam combining grating 504 should have high damage threshold and high broadband diffraction efficiency.

While the invention has been disclosed in connection with the preferred embodiments shown and described in detail, various modifications and improvements thereon will become readily apparent to those skilled in the art. For example, instead of using optical fibers as a gain medium, a gain medium may be fabricated on a planar surface as an array of optical waveguides. This fabrication method alleviates the requirement of handling multiple fibers. Accordingly, the spirit and scope of the present invention is to be limited only by the following claims.

What is claimed is:

1. A laser device, comprising:
a plurality of optical gain elements emitting corresponding laser beams;
a first beam combiner that combines the laser beams to form an overlapping beam;
a mode-locking device that intercepts the overlapping beam and commonly mode-locks the laser beams;
a plurality of optical amplifying elements, each amplifying element receiving an output beam from a corresponding optical gain element and producing an amplified beam; and
a second beam combiner that combines the amplified beams to produce an overlapping amplified output beam.

2. The device of claim 1, further comprising
a phase-measuring device intercepting a portion of the overlapping beam and determining a phase characteristic of the overlapping beam; and
a phase adjuster configured to separately adjust an optical path length of the laser elements in response to the determined phase characteristic.

3. The device of claim 1, wherein the optical gain elements comprise an optical waveguide.

4. The device of claim 3, wherein the optical waveguide comprises a semiconductor waveguide.

5. The device of claim 3, wherein the optical waveguide comprises an optical fiber waveguide.

6. The device of claim 5, where the optical fiber waveguide comprises a dopant selected from Ytterbium and Erbium.

7. The device of claim 1, where the mode-locking device comprises a semiconductor saturable absorber mirror (SESAM).

8. The device of claim 2, wherein the phase adjuster adjusts at least one of a geometric path and a refractive index of an optical element disposed in the optical path.

9. The device of claim 8, wherein the refractive index is adjusted by injecting carriers into at least a region of the laser elements.

10. The device of claim 8, wherein the geometrical path is adjusted by an element selected from the group of intra-cavity prism, liquid crystal and chirped dielectric mirror.

11. The device of claim 2, wherein the phase-measuring device comprises a frequency-resolved optical gating (FROG) device.

12. The device of claim 2, wherein the phase-measuring device determines simultaneously a phase relationship between a plurality of the gain elements based on the phase characteristic of the overlapping pulsed output beam.

13. The device of claim 1, wherein the first beam combiner comprises a diffractive optical element.

14. The device of claim 1, wherein the first beam combiner comprises an optical grating.

15. The device of claim 1, wherein the second beam combiner comprises a diffractive optical element.

16. The device of claim 1, wherein the second beam combiner comprises an optical grating.

17. The device of claim 1, wherein the mode-locking device retro-reflects the overlapping beam to the first beam combiner.

18. The device of claim 1, wherein the laser device is an external cavity laser device and further includes an intra-cavity etalon that narrows a spectral width of the laser beams emitted by the optical gain elements.

19. The device of claim 1, wherein the optical amplifying elements comprise optically pumped fibers.

20. The device of claim 1, wherein the optical amplifying elements comprise electrically pumped semiconductor waveguides.

21. The device of claim 19, wherein the optically pumped fibers are polarization-maintaining fibers.

22. The device of claim 19, wherein the optically pumped fibers comprise single mode fibers.

23. The device of claim 19, wherein the optical fibers comprise multimode fibers that are bent so as to operate substantially in single mode.

24. The device of claim 1, further comprising an optical coupling unit that couples the output beam from an optical gain element to a corresponding one of the optical amplifying elements.

25. The device of claim 24, wherein the optical coupling unit comprises an optical switch that selectively switches the output beam to the corresponding amplifying element.

26. The device of claim 24, wherein the optical switch comprises a Pockels cell.

27. The device of claim 24, wherein optical switch receives a timing signal that is synchronized with the commonly mode-locked laser beams.

28. A laser device, comprising:
a plurality of optical gain elements emitting corresponding laser beams;
a first beam combiner that combines the laser beams to form an overlapping beam;
a Q-switching device that intercepts the overlapping beam and commonly Q-switches the laser beams;
a plurality of optical amplifying elements, each amplifying element receiving an output beam from a corresponding optical gain element and producing an amplified beam; and
a second beam combiner that combines the amplified beams to produce an overlapping amplified output beam.
